(19) United States
(12) Patent Application Publication
(10) Pub. No.: US 2023/0405477 A1
(43) Pub. Date: Dec. 21, 2023

(54) SERVER DEVICE, INFORMATION PROCESSING DEVICE, AND PRAISE EVALUATION METHOD

(71) Applicant: Sony Interactive Entertainment Inc., Tokyo (JP)

(72) Inventor: Yuki Ikeshita, Kanagawa (JP)

(73) Assignee: Sony Interactive Entertainment Inc., Tokyo (JP)

(21) Appl. No.: 18/331,317

(22) Filed: Jun. 8, 2023

(30) Foreign Application Priority Data
Jun. 16, 2022 (JP) 2022-097051

(51) Int. Cl. A63F 13/85; A63F 13/79; A63F 13/35

(52) U.S. Cl. CPC A63F 13/85; A63F 13/35; A63F 13/79

(57) ABSTRACT

Disclosed herein is a server device including one or more processors having hardware. The one or more processors obtain praise information indicating that a player has praised another player, award points to the player who has praised the other player, on the basis of the praise information, award points to the other player who has been praised, on the basis of the praise information, count the points awarded by praising and the points awarded by being praised, for each player, and conduct evaluation regarding praise on the basis of the counted points.

### CROSS REFERENCE TO RELATED APPLICATIONS

This application claims the benefit of Japanese Priority Patent Application JP 2022-097051 filed Jun. 16, 2022, the entire contents of which are incorporated herein by reference.

### BACKGROUND

The present disclosure relates to a technique in which a player is capable of giving praise to another player who plays a game together.

In an online multiplayer game in which a plurality of players join the same session, the players enjoy a match in cooperation with each other. In recent years, it has been common to play the game together among players who do not know each other, and it is preferable to achieve a system in which, when a player is impressed with behavior of a certain player during a match, he/she can give praise to the corresponding player.

### SUMMARY

A player who receives praise can recognize that his/her behavior during a match has been highly evaluated by another player, leading to increase in motivation to multiplay. Stimulation of use of such a system as to allow a player to give praise to another player is expected to further increase attractivity of the online multiplayer game.

Accordingly, it is desirable to provide a technique in which a player is capable of giving praise to another player who has played a game together.

According to an embodiment of the present disclosure, there is provided a server device including one or more processors having hardware. The one or more processors obtain praise information indicating that a player has praised another player, award points to the player who has praised the other player, on the basis of the praise information, award points to the other player who has been praised, on the basis of the praise information, count the points awarded by praising and the points awarded by being praised, for each player, and conduct evaluation regarding praise on the basis of the counted points.

According to another embodiment of the present disclosure, there is provided an information processing device that is operated by a player, including one or more processors having hardware. The one or more processors send praise information indicating that the player has praised another player to a server device, obtain evaluation information regarding praise for the player on the basis of points awarded to the player by praising the other player and points awarded to the player by being praised by the other player, and display the evaluated information.

According to still another embodiment of the present disclosure, there is provided a praise evaluation method of conducting evaluation regarding praise, including obtaining praise information indicating that a player has praised another player, awarding points to the player who has praised the other player, on the basis of the praise information, awarding points to the other player who has been praised, on the basis of the praise information, counting the points awarded by praising and the points awarded by being praised, for each player, and conducting evaluation regarding praise on the basis of the counted points.

It is noted that any combinations of the constituent components described above and the expressions of the present disclosure that are converted between a method, an apparatus, a system, a recording medium, a computer program, and the like are also effective as modes of the present disclosure.

According to the present disclosure, it is possible to provide a technique in which a player is capable of giving praise to another player who has played a game together.

### BRIEF DESCRIPTION OF THE DRAWINGS

FIG. 1 is a diagram illustrating an information processing system according to an embodiment of the present disclosure;

FIG. 2 is a block diagram illustrating a hardware configuration of an information processing device;

FIG. 3 is a block diagram illustrating functional blocks of the information processing device;

FIG. 4 is a view illustrating one example of a game image to be displayed;

FIG. 5 is a view illustrating a list of players;

FIG. 6 is a view illustrating an example of a screen for selecting a type of praise;

FIG. 7 is a block diagram illustrating functional blocks of a server device; and

FIG. 8 is a view illustrating a display example of evaluation information which is derived for a player.

### DETAILED DESCRIPTION OF THE PREFERRED EMBODIMENT

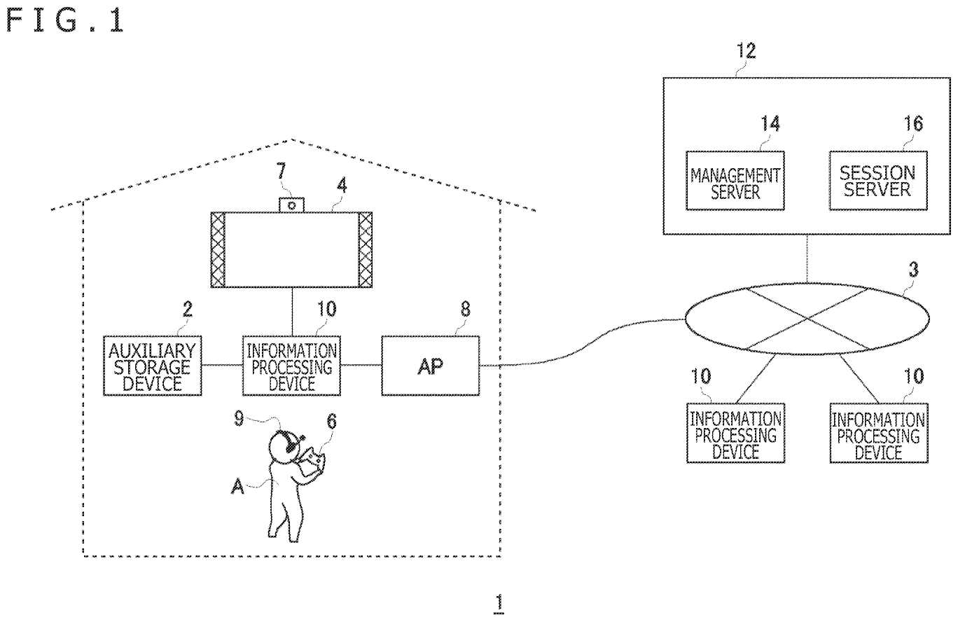

FIG. 1 is a diagram illustrating an information processing system 1 according to an embodiment of the present disclosure. The information processing system 1 includes a plurality of information processing devices 10 which are operated by a plurality of users, and a server device 12. These devices are connected to each other via a network 3 such as the Internet or a local area network (LAN). An access point (hereinafter, referred to as an “AP”) 8 has a function of a wireless access point or a router, and the information processing device 10 is connected through the AP 8 to the server device 12 in a wireless or a wired manner so as to be able to communicate with the server device 12 on the network 3.

The information processing device 10 is connected to an input device 6 operated by a user in a wireless or a wired manner. The input device 6 outputs operation information indicating a result of operation by the user to the information processing device 10. When receiving the operation information from the input device 6, the information processing device 10 reflects the operation information in processing of system software or application software, and causes an output device 4 to output a result of the processing. In the information processing system 1, the information processing device 10 may be a game device (game console) that executes game software. The input device 6 may be equipment, such as a game controller, which supplies the operation information regarding the user to the information processing device 10. Note that the input device 6 may be an input interface such as a keyboard or a mouse.

An auxiliary storage device 2 may be a large capacity storage device such as a hard disk drive (HDD) or a solid state drive (SSD). The auxiliary storage device 2 may be a built-in type storage device or may be an external storage device connected to the information processing device 10 by a universal serial bus (USB) or the like. The output device 4 may be a television set including a display which outputs an image and a speaker which outputs sound, or may be a head mounted display. The output device 4 may be connected to the information processing device 10 via a cable or wirelessly.

A camera 7 functioning as an imaging device is provided in the vicinity of the output device 4 to capture an image of a space around the output device 4. In FIG. 1, the camera 7 is attached to an upper portion of the output device 4 as an example. However, the camera 7 may be disposed on a side portion or a lower portion of the output device 4. In either case, the camera 7 may be disposed at a position at which to be able to capture an image of the user located in front of the output device 4. The camera 7 may be a stereo camera. In the embodiment, the user wears a headset 9 for having a voice chat.

The server device 12 includes a management server 14 and a session server 16 and is maintained and managed by an operating entity that operates the information processing system 1. The server device 12 may include another type of a server. The user has a user account by which the user can be uniquely identified and signs in to the management server 14 with use of the user account to thereby be able to use a service provided by the management server 14 and the session server 16. The server device 12 may include a plurality of servers. Alternatively, a plurality of functions may be integrated into one server.

The session server 16 manages a state of a session created by a game. In the session created by the game, the session server 16 manages information such as a title of the game, a user account of a user (session leader) who has created the session, a user account of another user who joins the session, and the duration for the session. When there is a change in the state of the session, the system software of the information processing device 10 sends information indicating the change to the session server 16, and the session server 16 may manage the latest state of the session.

When a single user (for example, a user A) activates the game and selects a multiplayer mode of the game, the game creates a session related to the game. When another user joins the game session thus created, a plurality of users can play the game together on the game session to be able to have a chat with each other. There are various methods to join the game session. For example, the user sends a message for a request for participation in the game session to the session leader, and the session leader accepts the request, so that the user can join the game session.

In the embodiment, a plurality of users have a voice chat while playing the game. In the following description, a user who plays the game is also referred to as a “player.” An information processing device 10 of a player is connected to an information processing device 10 of another player in a Peer to Peer (P2P) connection, and game operation information is exchanged among the plurality of information processing devices 10, so that an online multiplayer mode is achieved. Also, voice chat data is exchanged among the plurality of information processing devices 10, so that voice chat is achieved. Note that a chat server is provided in the server device 12, and via the chat server, voice chat data may be exchanged among the plurality of information processing devices 10.

The management server 14 has a function of accepting, from a player, information (hereinafter, also referred to as “praise information”) indicating that the player has praised another player. In the information processing system 1 of the embodiment, when the player meets a player who behaves cooperatively or friendly in a match, the player can anonymously give praise to the corresponding player after the end of the match. The information processing device 10 displays a list of members who have played the game together after the online multiplayer mode ends, and the player can select one player from the list of the members and give praise to the selected player. Note that, when there is no player to whom the player wants to give praise, the player does not have to force himself/herself to give praise to anyone.

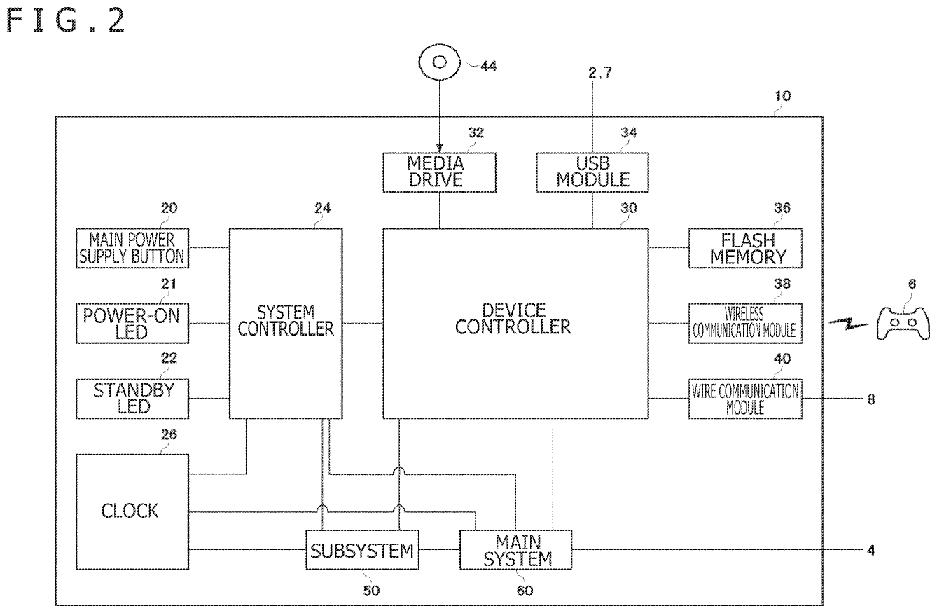

FIG. 2 illustrates a hardware configuration of the information processing device 10. The information processing device 10 includes a main power supply button 20, a power-on light-emitting diode (LED) 21, a standby LED 22, a system controller 24, a clock 26, a device controller 30, a media drive 32, a USB module 34, a flash memory 36, a wireless communication module 38, a wire communication module 40, a subsystem 50, and a main system 60.

The main system 60 includes a main central processing unit (CPU), a memory as a main storage device, a memory controller, a graphics processing unit (GPU), and the like. The GPU is used mainly for computing processing of a game program. The main CPU has a function of activating an operating system (OS) and executing the game program installed in the auxiliary storage device 2 under an environment provided by the OS. The subsystem 50 includes a sub-CPU, a memory as a main storage device, a memory controller, and the like. The subsystem 50 does not include a GPU.

The main CPU has the game program installed in the auxiliary storage device 2 or on a read only memory (ROM) medium 44, whereas the sub CPU does not have such a function. However, the sub CPU has a function of accessing the auxiliary storage device 2 and a function of sending and receiving data to and from the server device 12. The sub CPU has such a limited processing function only, and can thus be operated with power consumption lower than the power consumption in operation of the main CPU. These functions of the sub CPU are executed when the main CPU is in a standby state.

The main power supply button 20 is an input section by which operating input from the user is performed. The main power supply button 20 is provided to a front surface of a casing of the information processing device 10. The main power supply button 20 is operated to turn on or off the supply of power to the main system 60 of the information processing device 10. The power-on LED 21 is lighted when the main power supply button 20 is turned on. The standby LED 22 is lighted when the main power supply button 20 is turned off. The system controller 24 detects pressing of the main power supply button 20 by the user.

The clock 26 is a real-time clock. The clock 26 generates the current date and time information and supplies the generated date and time information to the system controller 24, the subsystem 50, and the main system 60.

The device controller 30 is configured as a large-scale integrated circuit (LSI) which executes delivery of information between devices like a south bridge. As illustrated in FIG. 2, such devices as the system controller 24, the media drive 32, the USB module 34, the flash memory 36, the wireless communication module 38, the wire communication module 40, the subsystem 50, and the main system 60 are connected to the device controller 30. The device controller 30 absorbs differences between electrical characteristics of the respective devices and differences between data transfer rates, and controls data transfer timing.

The media drive 32 is a drive device that is loaded with the ROM medium 44 on which such application software as a game and license information are recorded, and that drives the ROM medium 44 to read a program, data, and the like from the ROM medium 44. The ROM medium 44 is a read-only recording medium such as an optical disc, a magneto-optical disc, or a Blu-ray disc.

The USB module 34 is a module connected to an external apparatus by a USB cable. The USB module 34 may be connected to the auxiliary storage device 2 and the camera 7 by a USB cable. The flash memory 36 is an auxiliary storage device forming an internal storage. The wireless communication module 38 performs wireless communication with the input device 6, for example, using a communication protocol such as a Bluetooth (registered trademark) protocol or Institute of Electrical and Electronics Engineers (IEEE) 802.11 protocol. The wire communication module 40 performs wire communication with an external apparatus and is connected to the network 3 via the AP 8.

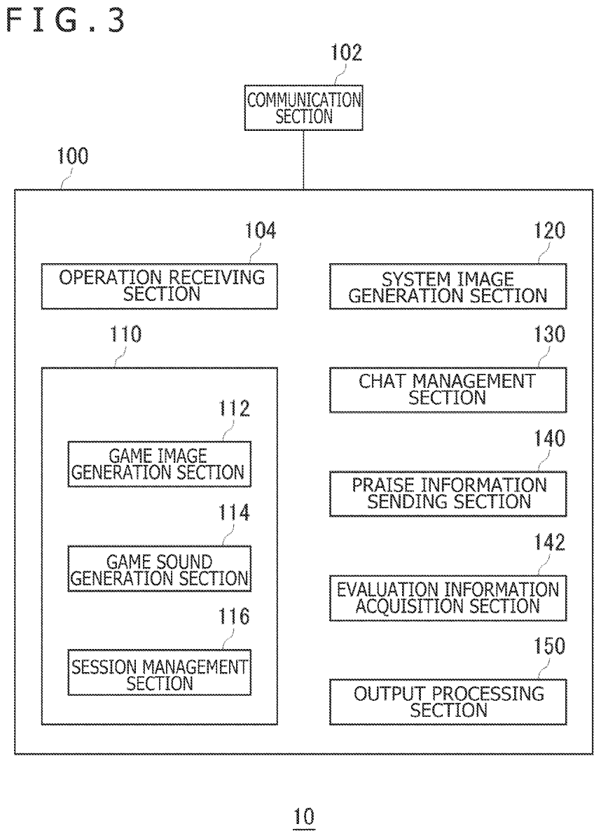

FIG. 3 illustrates functional blocks of the information processing device 10. The information processing device 10 in the embodiment includes a processing section 100 and a communication section 102 and has a function of sending information indicating that a user (player) gives praise to another player who has played the game together, to the server device 12, or receiving evaluation regarding the praise for the user from the server device 12.

The processing section 100 includes an operation receiving section 104, a game executing section 110, a system image generation section 120, a chat management section 130, a praise information sending section 140, an evaluation information acquisition section 142, and an output processing section 150. The game executing section 110 has a game image generation section 112, a game sound generation section 114, and a session management section 116.

The information processing device 10 includes a computer, and the computer executes a program, thereby achieving various functions indicated in FIG. 3. The computer has a memory in which a program is loaded, one or more processors that execute the loaded program, an auxiliary storage device, another LSI, and the like as hardware. The processor includes a plurality of electronic circuits including semiconductor integrated circuits and LSIs, and the plurality of electronic circuits may be mounted on a single chip or a plurality of chips. The functional blocks indicated in FIG. 3 are implemented in cooperation with hardware and software. Thus, it will be understood by those skilled in the art that these functional blocks may be variously implemented by hardware only, by software only, or by a combination of hardware and software.

The communication section 102 receives operation information regarding operation by the user from an input section of the input device 6 and provides the received information to the operation receiving section 104. Also, the communication section 102 communicates with the management server 14 and the session server 16 to exchange various types of information and data with each other. The communication section 102 may have functions of both the wireless communication module 38 and the wire communication module 40.

The operation receiving section 104 receives operation information on the input device 6 through the communication section 102. In the embodiment, the game executing section 110 executes a game program and generates image data and sound data of the game. A function to be provided as the game executing section 110 is implemented by the system software, a game program, or hardware such as the GPU that executes rendering processing or the like. It is to be noted that a game is by way of example of an application, and the game executing section 110 may execute an application other than a game.

When the user selects the multiplayer mode of the game, the session management section 116 creates a session under a condition that a connection environment with the network 3 is good, and notifies the session server 16 of the user ID of the user and session information including identification information (game ID) of the game, and the like. Note that the game prepares a menu item for explicitly “creating a session” in advance, and when the user selects the menu item, the session management section 116 may create a session. In the embodiment, the user A (player A) selects the multiplayer mode and creates a session.

When the session is created, the session server 16 returns the identification information (session ID) of the session to the game and manages a state of the session. In a case in which the user A allows the session to be published, the session server 16 publishes the session on the network 3, so that another user can find and join the session. The information processing devices 10 of the plurality of users who join the session are connected with one another in a P2P communication.

The session management section 116 holds the identification information (user ID) of each of the plurality of users who join the session and manages the participant users as players in a session group. The user ID may be a user account, and may be identification information different from the user account. For example, the user ID may be an online ID to be used online. The session management section 116 manages a player who newly joins the session or a player who leaves the session, and provides the user IDs of all players included in the session group to the chat management section 130. Thus, the chat management section 130 recognizes all players who join the session.

When the chat management section 130 receives a request for participating in a chat from a player who joins the session, the chat management section 130 allows the player to join a chat room. In the embodiment, a session leader is a “user A,” and when other players join the chat room, a plurality of players can enjoy a match in the online multiplayer mode, while having a chat.

During the match, the operation receiving section 104 supplies the operation information on the input device 6 by the player A and the operation information on the input device by another player to the game executing section 110 and executes computing processing for moving characters operated by the plurality of players and non-player characters (NPC) in a virtual space, on the basis of the operation information. The game image generation section 112 includes a GPU and receives a computing processing result in the virtual space and generates game image data from a viewpoint position (virtual camera) in the virtual space. The game sound generation section 114 generates game sound data from the viewpoint position in the virtual space.

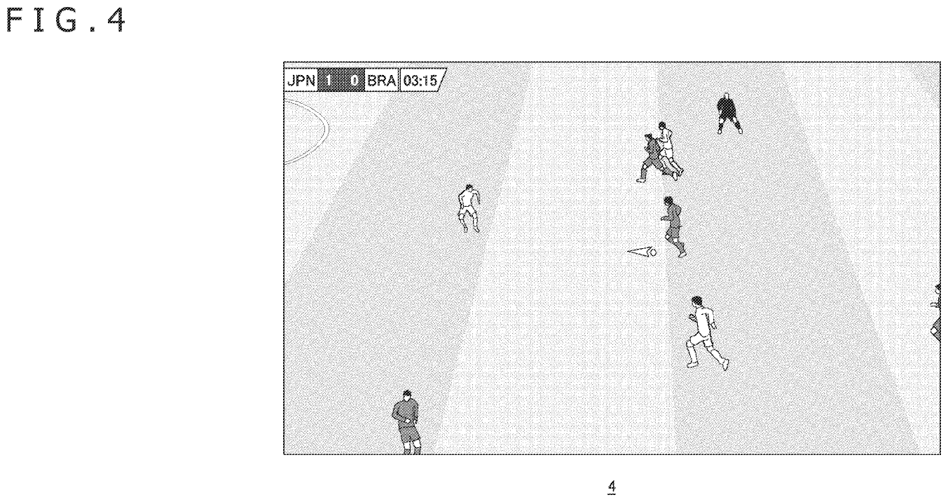

FIG. 4 illustrates an example of a game image displayed on the output device. The output processing section 150 displays a game image from the output device 4, and outputs game sound from the headset 9. Note that, in a case in which the user does not wear the headset 9, the output processing section 150 may output the game sound from a speaker of the output device 4.

In the information processing system 1 of the embodiment, when the match of the online multiplayer game ends, the player can give praise to another player who has joined the match.

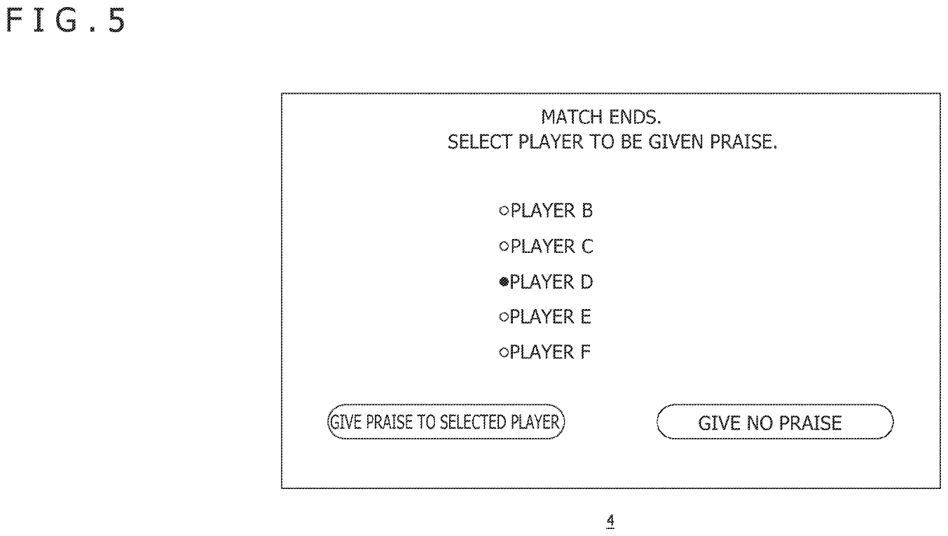

FIG. 5 indicates an example of a list of players to be displayed after the match ends. When the match ends, the game image generation section 112 generates a list of players who have joined the match, and the output processing section 150 displays the generated list on the output device 4. In FIG. 5, names of the players who have played with the player A are displayed. Note that it is preferable to display features such as character names and icons which have been used by other players in the match in such a way that the player A can identify the other players. If the player A does not want to give praise to anyone, the player A presses a button “GIVE NO PRAISE” and gets out of this player list screen.

The player A can give praise to only one player in one match, for example. The number of people to which the player A can give praise may suitably be determined by the operating entity that operates the information processing system 1. However, it is not preferable to give praise to an unlimited number of people. It is preferable to give praise to a predetermined number of people. For example, the number of people to which the player A can give praise may be determined according to the number of players who have joined the match. If the number of players who have joined the match is equal to or smaller than the predetermined number, the number of people to which the player A can give praise is one. If the number of players who have joined the match exceeds the predetermined number, the player A can give praise to a plural number of people. Also, in order to prevent the player A from giving praise to a particular player only, after the player A has given praise to a certain player, the player A may be restricted from giving praise to the same player in a predetermined period of time (12 hours, for example).

Note that, in order to prevent members in a group from exchanging praise to each other, the player A may be restricted from giving praise to his/her friend. Accordingly, in a case in which the player A plays a match with his/her friend, the friend is excluded from a friend list and hidden in display, or if the friend is included in the friend list, the friend is displayed in an unselectable state.

In the example indicated in FIG. 5, the player A is selecting a “player D” as a person to be given praise. The player A selects the “player D” and then presses a button “GIVE PRAISE TO SELECTED PLAYER,” so that the player A can give praise to the player D anonymously.

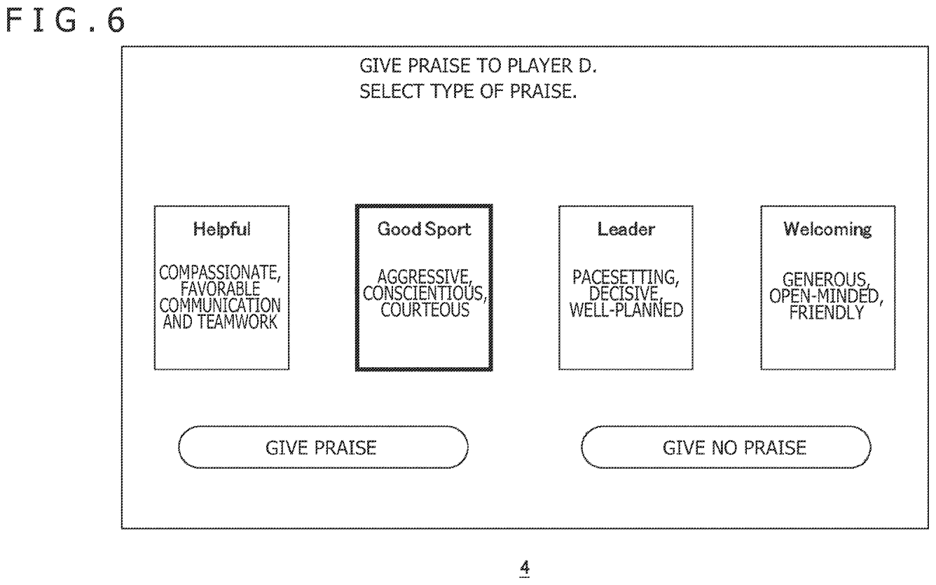

FIG. 6 indicates an example of a screen for selecting a type of praise. On the player list screen indicated in FIG. 5, the player A presses the button “GIVE PRAISE TO SELECTED PLAYER,” the game image generation section 112 generates a screen for selecting a type of praise, and the output processing section 150 displays the screen on the output device 4. On the screen for selecting a type of praise, the following four types of praise may be prepared.
“Helpful”
   Compassionate, favorable communication and teamwork
“Good Sport”
   Aggressive, conscientious, courteous
“Leader”
   Pacesetting, decisive, well-planned
“Welcoming”
   Generous, open-minded, friendly

The player A selects praise suitable for the player D from among “Helpful,” “Good Sport,” “Leader,” and “Welcoming,” and then presses the button “GIVE PRAISE.” In the example indicated in FIG. 6, “Good Sport” is being selected. The praise information sending section 140 sends information (praise information) indicating that the player A praises the player D to the management server 14 through the communication section 102.

In the foregoing description, such a case that the player A praises the player who has joined the same session has been described. However, each of the other players B to F can also praise a player other than himself/herself in a similar manner. For example, the player C praises the player A, and the information processing device 10 of the player C may send information indicating that the player C has praised the player A to the management server 14. Note that the action of praising another player is not forced, and accordingly, the player does not have to force himself/herself to praise another player.

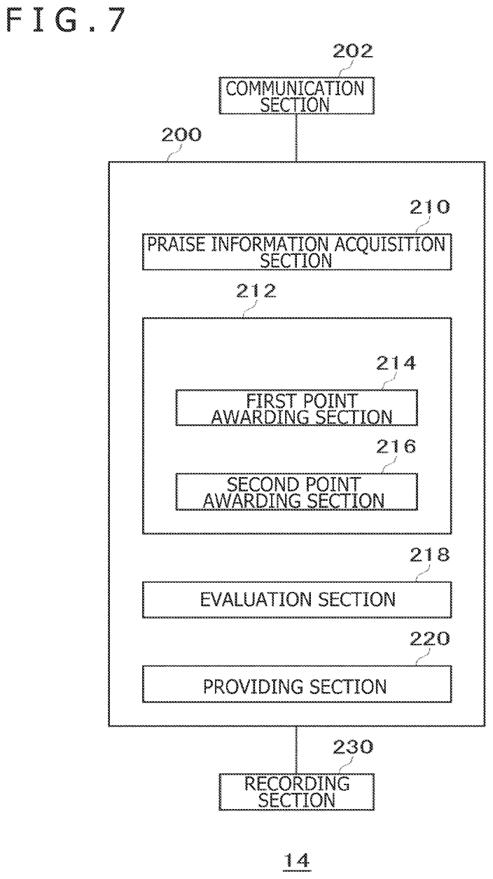

FIG. 7 indicates functional blocks of the management server 14. The management server 14 of the embodiment includes a processing section 200, a communication section 202, and a recording section 230 and has a function of processing praise information to be sent from the information processing device 10 of each player. The processing section 200 includes a praise information acquisition section 210, a point awarding section 212, an evaluation section 218, and a providing section 220. The point awarding section 212 has a first point awarding section 214 and a second point awarding section 216.

The management server 14 includes a computer, and the computer executes a program, thereby achieving various functions indicated in FIG. 7. The computer has a memory in which a program is loaded, one or more processors that execute the loaded program, an auxiliary storage device, another LSI, and the like as hardware. The processor includes a plurality of electronic circuits including semiconductor integrated circuits and LSIs, and the plurality of electronic circuits may be mounted on a single chip or a plurality of chips. The functional blocks indicated in FIG. 7 are implemented in cooperation with hardware and software. Thus, it will be understood by those skilled in the art that these functional blocks may be variously implemented by hardware only, by software only, or by a combination of hardware and software.

The praise information acquisition section 210 acquires praise information indicating that the player praises another player through the communication section 202 and records the praise information in the recording section 230. The praise information may include at least identification information (user ID) of the player who has praised another player, identification information (user ID) of another player who has been praised, and information (type information) identifying the type of praise that has been selected. In the above-described example, the player A has praised the player D in terms of “Good Sport.” The praise information sent from the information processing device 10 of the player A includes the user ID of the player A as the identification information on the player who has praised, the user ID of the player D as the identification information on the player who has been praised, and “Good Sport” as the type information. The point awarding section 212 accumulates a point relating to the praise for each player and derives the accumulated point.

The first point awarding section 214 has a function of awarding a point to the player who has praised another player, on the basis of the praise information. The number of points to be awarded to a player each time the player praises another player is X point. For example, in a case in which the player A has praised the player D, the first point awarding section 214 awards X point to the player A, and adds X point to the cumulative total point that has been accumulated so far by the player A praising other players. In a case in which the player A has praised other players N times, the first point awarding section 214 derives the number of points for the player A as N×X points.

The second point awarding section 216 has a function of awarding a point to the player who has been praised, on the basis of the praise information. The number of points to be awarded to a player each time the player is praised is Y point. For example, in a case in which the player C has praised the player A, the second point awarding section 216 awards Y point to the player A, and adds Y point to the cumulative total point that has been accumulated so far by the player A being praised by other players. In a case in which the player A has been praised by other players M times, the second point awarding section 216 derives the number of points for the player A as M×Y points.

The evaluation section 218 conducts an evaluation regarding praise, on the basis of points obtained by counting the points that have been awarded to each player by praising other players and the points that have been awarded to each player by being praised by other players. In an example of the player A, the evaluation section 218 adds the points (N×X points) to be awarded to the player A by praising other players to the points (M×Y points) to be awarded to the player A by being praised by other players, to thereby determine a level value corresponding to the added number of points. The level value represents one stage when the number of points is divided into a plurality of stages. The higher the level value is, the more number of times the player has been praised by other players, or the more number of times the player has praised other players.

The evaluation section 218 may determine the level value with use of the following (Equation 1).

(N×X+M×Y)/L (Equation 1)

L represents a constant number and may be 100, for example.

The evaluation section 218 calculates (Equation 1) and obtains (Quotient) and (Remainder).

In a case in which the (Remainder) is zero here, the evaluation section 218 determines (Quotient) as the level value. Thus, when the equation (N×X+M×Y)=300 and (Quotient)=3 and (Remainder)=0, the evaluation section 218 evaluates the level value regarding the praise for the player A as “3.”

In contrast, in a case in which the Remainder is other than zero, the evaluation section 218 determines ((Quotient)+1) as the level value. Thus, when the equation (N×X+M×Y)=301 and (Quotient)=3 and (Remainder)=1, the evaluation section 218 evaluates the level value regarding the praise for the player A as “4.”

The evaluation section 218 conducts an evaluation regarding the praise by adding the points obtained by the player praising other players, so that motivation of the player for praising other players can be enhanced. Hence, it is possible to stimulate actions of users who give praise to other players.

Note that the number of points X to be awarded to the user as a result of praising other players may be relatively smaller than the number of points Y to be awarded to the user as a result of being praised by other players. For example, when the number of points X is one, the number of points Y may be two. By setting a relation X<Y, at a time of calculating the level value, it is possible to enhance a relative value to being praised. Y may be three times or more of X.

The evaluation section 218 derives the percentage of the number of times of being praised for each praise type, on the basis of the praise information recorded in the recording section 230. In the following, the number of times that the player has received praise is indicated for each praise type.
Helpful 18 times
Good Sport 78 times
Leader 30 times
Welcoming 24 times

Accordingly, the evaluation section 218 derives the percentage of each praise type as below.
Helpful 12%
Good Sport 52%
Leader 20%
Welcoming 16%

The evaluation section 218 records the percentage of each praise type in the recording section 230.

The player A can make a request to the management server 14 for transmission of evaluation information regarding praise. When the information processing device 10 sends a request for the evaluation information to the management server 14, the providing section 220 reads the evaluation information regarding praise for the player A from the recording section 230 and sends the evaluation information to the information processing device 10 through the communication section 202. The evaluation information may include the level value that is an evaluation value regarding praise and the percentage of each type of praise to be received.

When the evaluation information acquisition section 142 acquires the evaluation information from the management server 14, the system image generation section 120 generates a system image including the evaluation information, and the output processing section 150 causes the generated system image to be displayed on the output device 4.

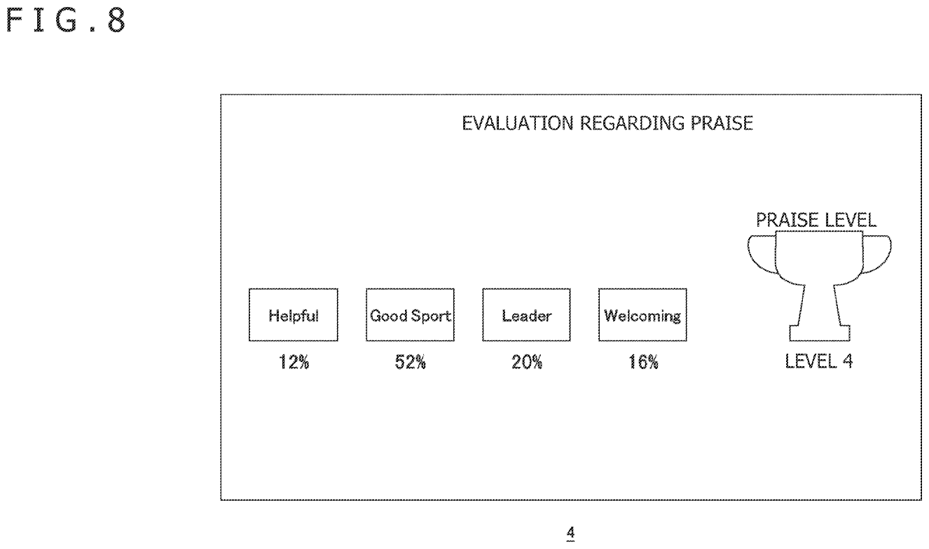

FIG. 8 illustrates a display example of the evaluation information which is derived for the player A. The evaluation information includes the percentage of the number of times the player A has received praise for each praise type and the level value. The player A can recognize what kind of play of the player A has been evaluated by viewing the percentage of praise. Also, the player A can increase motivation to performing behavior which raises the praise level by viewing the level value.

The present disclosure has been described above on the basis of embodiment thereof. The foregoing embodiment is illustrative, and it is to be understood by those skilled in the art that combinations of constituent elements and processing processes of the embodiment are susceptible of various modifications and that such modifications also fall within the scope of the present disclosure.

In the embodiment, a description that the number of points X to be awarded by praising other players may be relatively smaller than the number of points Y to be awarded by being praised by other players has been given. In a modification example, the number of points Y may be varied according to a play history of a player. For example, the number of points to be awarded when the player is praised by a player who has a short play history may be smaller than the number of points to be awarded when the player is praised by a player who has a long play history.

In the embodiment, a scheme in which a player praises another player has been described. Alternatively, the player can make use of this scheme when the player reports an impolite player with bad manners. In this case, the player selects an impolite player with bad manners from among participant players list after the end of a match and reports the impolite player to the management server 14. At this time, behavior of the impolite player may be able to be selected from a plurality of options. The management server 14 may count the reported number of times for each impolite player to hold it as one of the user information.

What is claimed is:

1. A server device comprising:
one or more processors having hardware,
wherein the one or more processors
obtain praise information indicating that a player has praised another player,
award points to the player who has praised the other player, on a basis of the praise information,
award points to the other player who has been praised, on the basis of the praise information,
count the points awarded by praising and the points awarded by being praised, for each player, and
conduct evaluation regarding praise on a basis of the counted points.

2. The server device according to claim 1, wherein the praise information includes at least identification information on the player who has praised the other player and identification information on the other player who has been praised.

3. The server device according to claim 1, wherein the one or more processors determine a level value according to the counted points.

4. The server device according to claim 1, wherein the points awarded by praising are relatively smaller than the points awarded by being praised.

5. An information processing device that is operated by a player, comprising:
one or more processors having hardware,
wherein the one or more processors
send praise information indicating that the player has praised another player to a server device,
obtain evaluation information regarding praise for the player on a basis of points awarded to the player by praising the other player and points awarded to the player by being praised by the other player, and
display the evaluated information.

6. A praise evaluation method of conducting evaluation regarding praise, comprising:
obtaining praise information indicating that a player has praised another player;
awarding points to the player who has praised the other player, on a basis of the praise information;
awarding points to the other player who has been praised, on the basis of the praise information;
counting the points awarded by praising and the points awarded by being praised, for each player; and
conducting evaluation regarding praise on a basis of the counted points.
